(19) United States
(12) Patent Application Publication
(10) Pub. No.: US 2011/0011940 A1
(43) Pub. Date: Jan. 20, 2011

(54) CODE PATTERN

(76) Inventor: Kenji Yoshida, Tokyo (JP)

Correspondence Address: Konomi Takeshita, Eight Penn Center, Suite 1300,, 1628 John F. Kennedy Blvd., Philadelphia, PA, 19103, US

(21) Appl. No.: 12/740,278

(22) PCT Filed: Oct. 30, 2008
(86) PCT No.: PCT/JP2008/003126

§ 371 Date: Aug. 24, 2010

(30) Foreign Application Priority Data
Oct. 30, 2007 (JP) 2007-282354

(51) Int. Cl. G06K 19/06

(52) U.S. Cl. 235/494

(57) ABSTRACT

A dot pattern and a code pattern, a plurality of which can be printed on a small area, are provided. In the dot pattern, a first and a second dot patterns are superimposed and arranged. The first and the second dot patterns provide a plurality of reference dots in regions of blocks on which predetermined dots are arranged, arrange a plurality of virtual reference points defined by the reference dots, arrange information dots that define information by distances and directions from the virtual reference points, and further define at least orientations and sizes of the blocks based on arrangements of the reference dots as indexes of the blocks. The block is arranged so that part of or entire the reference dots and/or the virtual reference dots of the first and second dot patterns are superimposed together, and the number of the block is one, or a plurality of the blocks are repeatedly arranged in lateral and longitudinal directions.

### CROSS REFERENCE TO RELATED APPLICATIONS

This application claims priority under 35 U.S.C. 119 based upon Japanese Patent. Application Serial No. 2007-282354, filed on Oct. 30, 2007. The entire disclosures of the aforesaid applications are incorporated herein by reference.

### FIELD OF THE INVENTION

The present invention relates to a code pattern generated by overlaying a plurality of code patterns

### BACKGROUND OF THE INVENTION

An information output method that outputs information, such as a sound, by reading a code pattern printed on a printed material is conventionally proposed. For example, there is proposed a method that stores, in advance, information corresponding to key information that is given to a storage unit and outputs information and the like by searching a key read out by a barcode reader. Also, there is proposed a technique that generates a dot pattern generated by arranging fine dots in accordance with a predetermined rule, retrieves the dot pattern printed on a printed material or the like as an image data with a camera, digitizes the data, and outputs sound information, in order to output large amount of information and programs. Other proposed methods include an information output method using a variety of code patterns such as a QR code.

In such code patterns, information amount that one piece of code pattern can store is limited. As such, if only one piece of code pattern is printed on a printed material, when a code pattern is used for a card used in a card game of a game arcade or the like, only limited parameters can be provided to the card with only one piece of code pattern, which raises a problem of lacking entertainment quality.

To solve such a problem, a card is proposed, where barcodes are printed along two adjacent sides or two opposing sides of the card for an entertainment system (for example, Japanese Patent Publication No. 2005-261645). According to Japanese Patent Publication No. 2005-261645, if the two barcodes are the same, recognition rate of the barcodes in the system improves, and if the barcodes are different, the system executes different processes between the case where the system recognizes both of the barcodes and the case where the system recognizes only one of them. In this way, the card can have flexibility and provide higher entertainment quality.

However, if a plurality of barcodes are printed on different areas of the printed material as the card proposed in Japanese Patent Publication No. 2005-261645, the portion occupied by the barcodes on the printed material becomes large. As a result, when the size of a printed material is small, there is a problem in which a plurality of barcodes cannot be printed.

### SUMMARY OF THE INVENTION

The invention was devised in consideration of such a point, and has a technical subject to provide a code pattern that allows a plurality of the code patterns to be printed on a small area.

A first aspect of the invention is a dot pattern that is made into a pattern with a coordinate value and/or a code value based on a predetermined algorithm, provided on at least one surface of a medium, and optically recognizable with an imaging unit, and in which a first and a second dot patterns are superimposed and arranged, wherein the first and the second dot patterns are dot patterns that provide a plurality of reference dots in regions of blocks on which predetermined dots are arranged, arrange a plurality of virtual reference points defined by the reference dots, arrange information dots that define information by distances and directions from the virtual reference points, and define at least orientations and sizes of the blocks based on arrangements of the reference dots as indexes of the blocks, the block is arranged so that part of or entire the reference dots and/or the virtual reference dots of the first and second dot patterns are superimposed together, and number of the block is one or a plurality of the blocks are repeatedly arranged in lateral and longitudinal directions.

GRID5, which is described later, is most appropriate for the algorithm for arranging the dot pattern of the invention. According to GRID5, a coordinate value and/or a code value can be defined in a dot pattern.

The dot pattern of the invention has a block arranged with reference dots and information dots and stores a dot code (bit information included in the dots) in this block as one unit, and one dot pattern is disposed or a plurality of the dot patterns are repeatedly disposed on a medium surface.

The dot pattern of the invention uses the arrangement of the reference dots as an index. The index and information derived from the index are correlated in the table registered in advance in an information-processing device. The index can be associated with an orientation of a block, a size of a block, a block number used for connecting a predetermined number of blocks, an arrangement rule of an information dot by which how the information dot is displaced from a virtual reference point is determined, a dot code format by which what kind of information dot is defined is determined (only a coordinate value, only a code value, or a coordinate value and a code value), and the like.

According to the structure, two dot patterns can be superimposed and arranged in the same block region, which achieves a significant effect in which a dot pattern where a plurality of code patterns can be printed in a small area can be provided.

A second aspect of the invention is the dot pattern according to the first aspect, wherein information dots are arranged in different forms in the first and the second dot patterns respectively.

The dot patterns of the invention are distinguished by a difference in shapes of information dots of the first dot pattern and the second dot pattern, such as a polygon including a triangle and a rectangle or a figure enclosed by a curved line including an oval.

A third aspect of the invention is the dot pattern according to the first aspect, wherein the second dot pattern that is made into a pattern in a different size from the first dot pattern is provided on a region overlapping a region on which the first dot pattern is provided, the first dot pattern and the second dot pattern are read by either one of two systems of imaging units having imaging elements with different resolutions, and either one of the dot patterns is recognizable with the resolution of the imaging unit.

“Made into a pattern in a different size” refers to that the scale sizes of the dot patterns differ. Specifically, the dot diameter of the two kinds of dot patterns and the distance between the dots differ in accordance with a predetermined scale factor.

By imaging with two systems of different imaging devices that have imaging elements of different resolutions, large dot patterns are recognized only by the imaging element of low resolution and small dot patterns are recognized only by the imaging element of high resolution, without giving a special image processing.

A fourth aspect of the invention is the dot pattern according to the third aspect, wherein the first dot pattern and the second dot pattern are read by either one of two systems of imaging units that image a medium near the medium and far from the medium, and either one of the dot patterns is recognizable by the imaging unit.

Two systems of different imaging devices that have imaging elements of different resolutions are disposed near the medium and far from the medium to read the dot pattern.

A fifth aspect of the invention is the dot pattern according the first aspect, wherein, in addition to the second dot pattern, a one-dimensional code pattern or a two-dimensional code pattern is arranged, and part of or entire the code pattern is superimposed by the first dot pattern.

There are a barcode as an example of the one-dimensional code pattern, and a QR code as an example of the two-dimensional code pattern.

One block or a plurality of blocks of the first dot patterns may be disposed in the second code pattern. If a plurality of blocks of dot patterns are disposed, the first dot patterns are repeatedly disposed in longitudinal and lateral directions within the area occupied the second code pattern.

A sixth aspect of the invention is the dot pattern according to the first to fifth aspects, wherein the first and the second dot patterns are printed with inks with characteristics that react differently to irradiation light.

In the dot patterns of the invention, dots are printed with two kinds of inks that absorb different wavelengths or two kinds of inks that reflect different wavelengths between the first dot pattern and the second dot pattern.

According to the invention, a plurality of code patterns are formed in the same region. Therefore, it is not required to sacrifice a large area for code patterns, and allows maintaining visual quality of the printed surface. Also, a small area can provide large amount of information. Furthermore, flexible code patterns can be provided, since code patterns can be formed by arbitrary combining a dot code, a barcode, a QR code, and the like.

### BRIEF DESCRIPTION OF THE DRAWINGS

FIG. 1 is an example where a first dot pattern and a second dot pattern are arranged in an overlapping area.

FIG. 2 is a diagram showing constituents of a dot pattern 3 and the position relationships thereamong.

FIGS. 3A and 3B are diagrams showing examples of an information defining method by way of an arrangement of an information dot 7. FIG. 3A is an example expressing 3-bit information, and FIG. 3B is an example of an information dot 7 having 2-bit information.

FIG. 4 is a diagram showing an example of an information defining method by way of another arrangement of an information dot 7.

FIGS. 5A to 5C are diagrams showing examples of an information defining method by way of arranging a plurality of information dots 7 per one grid. FIG. 5A is an example arranging two information dots 7; FIG. 5B is an example arranging four information dots 7; and FIG. 5C is an example arranging five information dots 7.

FIG. 6 is a diagram showing an example of a format used when extracting an information dot 7 from a dot pattern 3.

FIGS. 7A to 7D are diagrams showing other arrangement examples of grids including information dots 7. FIG. 7A is an example in which six (2×3) grids are arranged in one block; FIG. 7B is an example in which nine (3×3) grids are arranged in one block; FIG. 7C is an example in which 12 (3×4) grids are arranged in one block; and FIG. 7D is an example in which 36 grids are arranged in one block.

FIGS. 8A to 8C are diagrams showing examples of another dot pattern 3b. FIG. 8A is a diagram showing a position relationship of reference point dots 8a to 8e, virtual reference points 9a to 9d, and an information dot 7 in a dot pattern 3b. FIG. 8B is an example in which information is defined based the fact whether or not an information dot 7 exists on virtual reference points 9a to 9d. FIG. 8C is a diagram showing an example in which each two blocks are connected in horizontal and vertical directions respectively.

FIG. 9 is a diagram showing a format example of information bits in a block of a dot pattern 3.

FIGS. 10A to 10C are diagrams showing format examples of dot codes. FIG. 10A is an example where a dot code includes XY coordinate values, a code value, and a parity; FIG. 10B is an example where a format is changed depending on the place where a dot pattern 3 is provided; and FIG. 10C is an example where a dot code includes XY coordinate values and a parity.

FIGS. 11A to 11C are diagrams illustrating a method for using the arrangement of a reference dot of GRID 5 as an index.

FIGS. 12A to 12C are diagrams illustrating a method for using the arrangement of a reference dot of GRID 5 as an index.

FIGS. 13A to 13C are diagrams illustrating a method for using the arrangement of a reference dot of GRID 5 as an index.

FIG. 14 is a diagram illustrating a code pattern for judging two kinds of code patterns based on an arrangement rule, and virtual points of the two kinds are the same.

FIGS. 15A and 15B are diagrams illustrating a code pattern for judging two kinds of code patterns based on an arrangement rule, and virtual points of the two kinds are different.

FIG. 16 is a diagram illustrating a second embodiment.

FIGS. 17A and 17B are diagrams illustrating the second embodiment.

FIGS. 18A and 18B are diagrams illustrating the second embodiment.

FIGS. 19A to 19C are diagrams illustrating the second embodiment.

FIG. 20 is a diagram illustrating a third embodiment.

FIGS. 21A and 21D are diagrams illustrating the third embodiment.

FIG. 22 is a diagram illustrating the third embodiment.

FIG. 23 is coordinate tables of reference points of the second embodiment and the third embodiment.

FIGS. 24A to 24D are diagrams illustrating a fourth embodiment.

FIG. 25 is a diagram illustrating the fourth embodiment.

FIG. 26 is a diagram illustrating a case in which two kinds of code patterns are distinguished by irradiating irradiation light of different wavelengths, and the two kinds are fine dot patterns.

FIG. 27 is a diagram illustrating a case in which two kinds of code patterns are distinguished by irradiating irradiation light of different wavelengths, and the two kinds of the code patterns are a QR code and a fine dot pattern.

FIG. 28 is a diagram illustrating a case in which two kinds of code patterns are distinguished by irradiating irradiation light of different wavelengths, and the two kinds of the code patterns are a barcode and a fine dot pattern.

FIG. 29 is a diagram illustrating a case in which two kinds of code patterns are distinguished by irradiating irradiation light of different wavelengths, and the two kinds of the code patterns are a large dot pattern and a fine dot pattern.

FIG. 30 is a diagram illustrating wavelength characteristics of ink of a first code pattern and ink of a second code pattern when there is one source of irradiation light.

FIGS. 31A and 31B are diagrams illustrating wavelength characteristics of the first code pattern and the second code pattern when there are two sources of irradiation light and both of the code patterns are dot codes.

FIG. 32 is a diagram illustrating wavelength characteristics of the first code pattern and the second code pattern when there are two sources of irradiation light and the code patterns are a QR code and dot code or a barcode and dot code.

FIG. 33 is a diagram illustrating a case in which two kinds of code patterns are distinguished by accuracy of an imaging device or an image processing program and the two kinds of code patterns are a QR code and a fine dot pattern.

FIG. 34 is a diagram illustrating a case in which two kinds of code patterns are distinguished by accuracy of an imaging device or an image processing program and the two kinds of code patterns are a barcode and a fine dot pattern.

FIG. 35 is a diagram illustrating a case in which two kinds of code patterns are distinguished by accuracy of an imaging device or an image processing program and the two kinds of code patterns are a large dot pattern and a fine dot pattern.

### DETAILED DESCRIPTION OF THE INVENTION

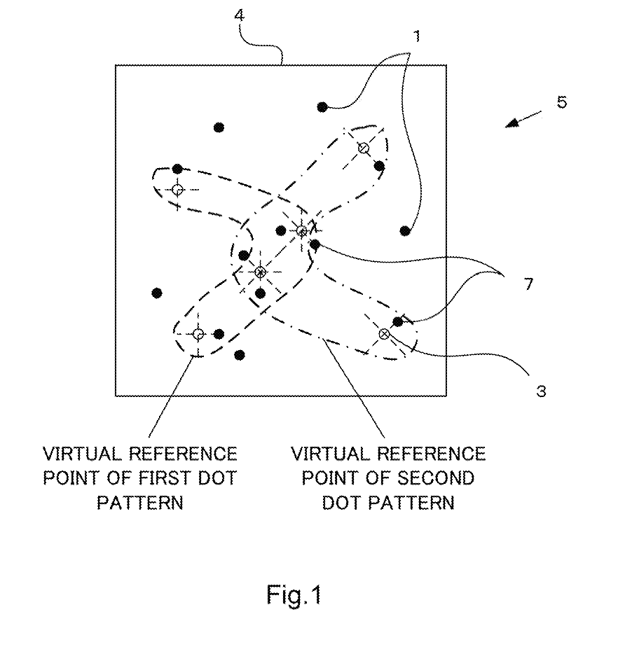

The overview of the invention will be described with reference to FIG. 1.

As shown in FIG. 1, the dot pattern of the invention can store entirely different kinds of code information (dot codes) by superimposing them on the same region. Such a dot pattern is read by an optical reading unit connected to an information-processing device and decoded to be used for a variety of use purposes, such as information input and device operation.

The fundamental principle of the dot pattern as an example of the code pattern of the invention will now be described.

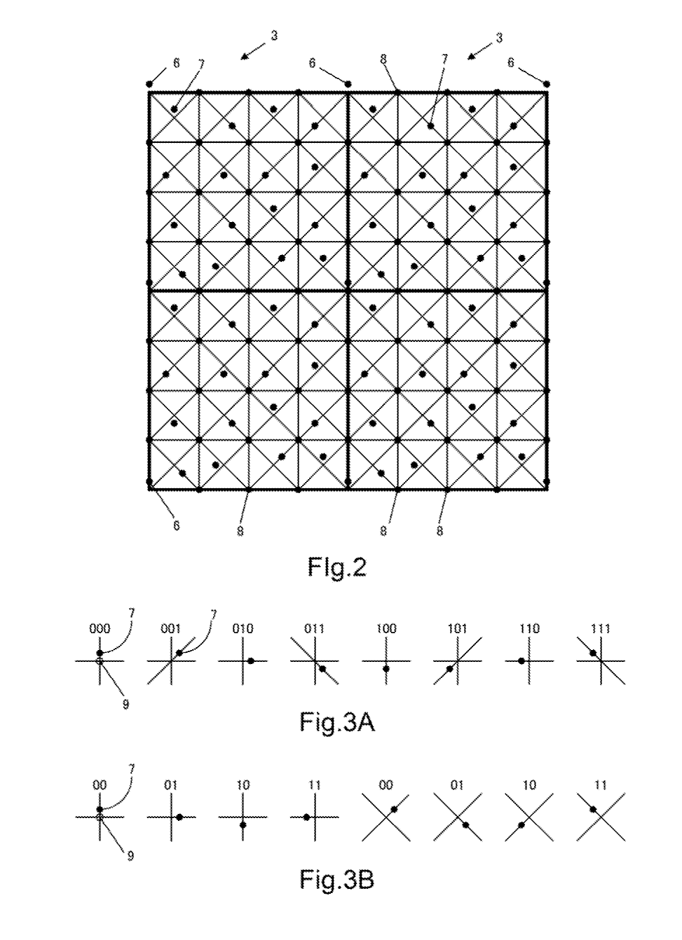

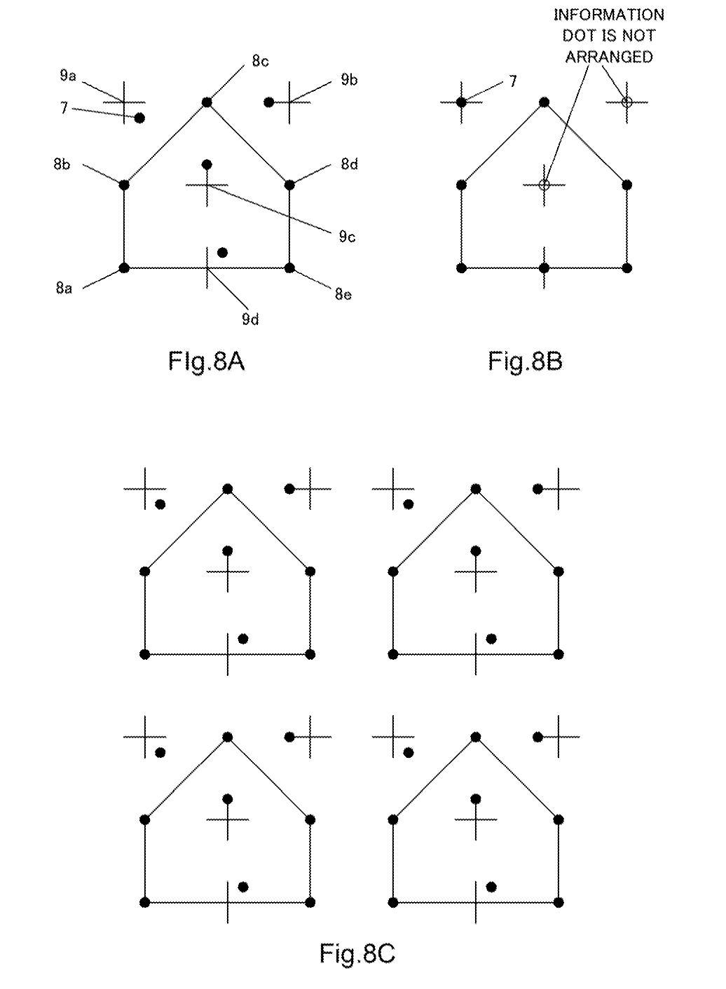

An example of a dot pattern 3 used in this embodiment (hereinafter, referred to as GRID1) is described with reference to FIGS. 2 to 7D. Also, an example of another dot pattern 3b (hereinafter, referred to as GRID5) is described with reference to FIGS. 8A to 8C. It should be noted that, in these drawings, grid lines in horizontal, vertical, and diagonal directions are added for convenience of description and do not exist in an actual printed surface.

<GRID1>

FIG. 2 shows constituents of the dot pattern 3 and a position relationship among the constituents. The dot pattern 3 is composed of a key dot 6, an information dot 7, and a reference grid point dot 8 (a key dot 6 and a reference grid point dot 8 are reference dots in GRID1).

A dot pattern 3 is generated by arranging fine dots, that is, a key dot 6, an information dot 7, and a reference grid point dot 8, in accordance with a predetermined rule for recognition of numerical information based on a dot code generation algorithm.

As shown in FIG. 2, a block of a dot pattern 3 which expresses information is composed of 5×5 reference grid point dots 8 arranged with reference to a key dot 6 and an information dot 7 arranged around a virtual grid point (virtual reference point of GRID1) surrounded by four reference grid point dots 8. This block defines arbitrary numerical information. It should be noted that, in the example of FIG. 2, four blocks of the dot pattern 3 (in bold frames) are arranged in parallel, provided, however, the dot pattern 3 is not limited to four blocks.

A key dot 6 is a dot arranged by shifting four reference grid point dots 8 at four corners of a block in a certain direction as shown in FIG. 2. This key dot 6 is a representative point of a block of a dot pattern 3 that includes an information dot 7. For example, this is a point obtained by shifting the reference grid point dots 8 at four corners of a block of a dot pattern 3 by 0.1 mm upward. However, this numerical value is not limited to this, and may vary depending on the size of a block of a dot pattern 3.

Preferably, the displacement of a key dot 6 is approximately 20% of a grid pitch to avoid false recognition with a reference grid point dot 8 and an information dot 7.

The information dot 7 is a dot used for recognition of a variety of information. The information dot 7 is disposed around a key dot 6 as a representative point and at the end point of a vector expressed with the starting point of a virtual grid point as a central point surrounded by a grid formed by four reference grid point dots 8.

The gap between an information dot 7 and a virtual grid point surrounded by four reference grid point dots 8 is preferably a gap approximately 15 to 30% of the distance between adjacent virtual grid points. If the distance between an information dot 7 and a virtual grid point is longer than this gap, the dots are easily recognized as a large cluster, which degrades visual quality of the dot pattern 3. On the contrary, if the distance between the information dot 7 and the virtual grid point is shorter than this gap, recognition of the vector quantity of information dot 7 with the adjacent virtual grid point as the starting point of the vector becomes difficult.

When retrieving the dot pattern 3 as image data using a scanner 4, a reference grid point dot 8 can calibrate a distortion of a lens, skewed imaging, expansion and contraction of a paper, a curved medium surface, and a distortion during printing. Specifically, a calibration function that converts distorted four reference gird point dots 8 into the original square, (Xn, Yn)=f(Xn′, Yn′), is obtained, and, using the same function, an information dot 7 is calibrated to obtain the vector of a correct information dot 7.

If the reference grid point dot 8 is disposed in a dot pattern 3, since a distortion attributable to a scanner 4 is calibrated in the image data of this dot pattern 3 that is retrieved by the scanner 4, the positions of dots can be accurately recognized even when retrieving image data of dot pattern 3 by the popular scanner 4 mounted with a lens of high distortion rate. Further, the dot pattern 3 can be accurately recognized even when reading the dot pattern 3 with the scanner 4 inclined with reference to the surface of the dot pattern 3.

If a scanner 4 reads dots with irradiation of infrared rays, a key dot 6, an information dot 7, and a reference gird point dot 8 are preferably printed using an invisible ink or a carbon ink that absorbs the infrared rays.

If a normal inkjet printer or the like is used to print a dot pattern 3, the gap between reference grid dots 8 (that is, the size of a grid) may be approximately 0.5 mm. If offset printing is used, the gap may be a minimum of approximately 0.3 mm.

If an exposure technology of a semiconductor production process is used to form a dot pattern 3, the gap between the reference grid point dots 8 may be several micro meters. Further, if a design rule of nano meter unit is used, a dot pattern 3 having finer dot gaps may be formed.

It will be appreciated that the gap between reference grid point dots 8 may be any value depending on the use purpose of the dot pattern 3, as long as the value is equal to or more than the minimum value.

Also, the diameter of a key dot 6, an information dot 7, and a reference grid point dot 8 is preferably approximately 10% of the gap between reference grid point dots 8.

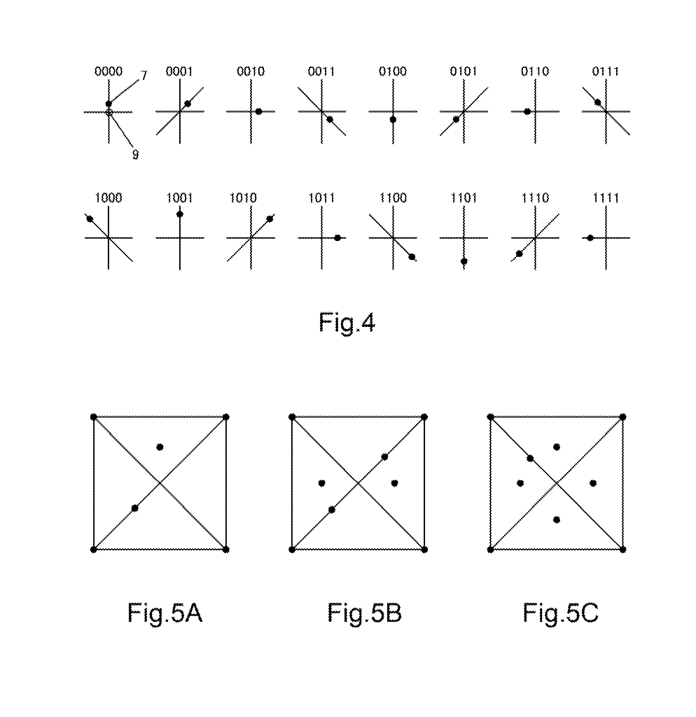

FIGS. 3A to 4 show an example of an information defining method by way of an arrangement of an information dot 7. FIGS. 3A to 4 are enlarged views showing an example of the position of an information dot 7 and bit expression of information defined by the position.

FIG. 3A shows an example of a defining method in which 3 bits are expressed by displacing the distance of an information dot 7 from a virtual grid point 9 (for example, 0.1 mm) and disposing the information dot 7 in eight directions by being rotated in a clockwise direction by 45 degrees each so that the information dot 7 can have a direction and a length when expressed as a vector. In this example, the dot pattern 3 includes 16 information dots 7 in a block, and can express 3 bits×6=48 bits.

FIG. 3B shows an example of a defining method of information dot 7 in which a dot pattern 3 has 2-bit information per grid. In this example, the information dot 7 is shifted from the virtual grid point 9 in a plus (+) direction and a diagonal (×) direction and 2-bit information is defined per information dot 7. This defining method is different from the defining method shown in FIG. 3A (that can define 48-bit information indeed), and can provide 32 bit (2 bits×16 grids) data by dividing a block into grids that is shifted in plus (+) directions and grid that is shifted in diagonal (x) directions depending on use purposes.

It should be noted that by combining a shifting method of plus (+) direction and a shifting method of diagonal (x) direction for each grid as a combination of shifting directions of information dots 7 disposed in 16 grids contained in a block, a maximum of 2¹⁶ (approximately 65,000) patterns of dot pattern formats can be realized.

FIG. 4 shows an example of an information defining method by way of another arrangement of information dot 7. In this defining method, 4-bit information can be expressed since, when arranging an information dot 7, two kinds of displacement amounts, long and short, from a virtual grid point 9 surrounded by reference grid point dots 8 are used and vector directions are eight directions defining 16 pattern arrangements.

When using this defining method, displacement amount of the long one is preferably approximately 25 to 30% of the distance between adjacent virtual grid points 9, and displace amount of the short one is preferably approximately 15 to 20%. However, the distance between the centers of the information dots 7 is preferably longer than the diameter of the information dots 7, so that the information dots 7 can be distinguished and recognized even when the directions in which the long and short information dots 7 are shifted are the same.

It will be appreciated that a method for defining 4-bit information is not limited to the above-described defining method, and 4 bits can also be expressed by arranging information dots 7 in 16 directions or may be varied in may ways.

FIGS. 5A to 5C show an example of an information defining method using a method for arranging a plurality of information dots 7 for each grid. FIG. 5A is an example of arranging two information dots 7; FIG. 5B is an example of arranging four information dots 7; and FIG. 5C shows an example of arranging five information dots 7.

Preferably, the number of information dots 7 per grid surrounded by four reference grid point dots 8 is one in consideration of visual quality. However, if visual quality is disregarded and large information amount is required, large amount of information can be defined by allocating 1 bit to one vector and expressing information dots 7 using a plurality of dots. For example, eight concentric vectors can express 2⁸ pieces of information per grid, expressing 2¹²⁸ pieces of information per block of 16 grids.

Recognition of a dot pattern 3 is performed, after retrieving the dot pattern 3 as image data by a scanner 4, first, by extracting a reference grid point dot 8, then, extracting a key dot 6 based on the fact that there is no dot at the position where a reference grid point dot 8 is supposed to be, and then, extracting an information dot 7.

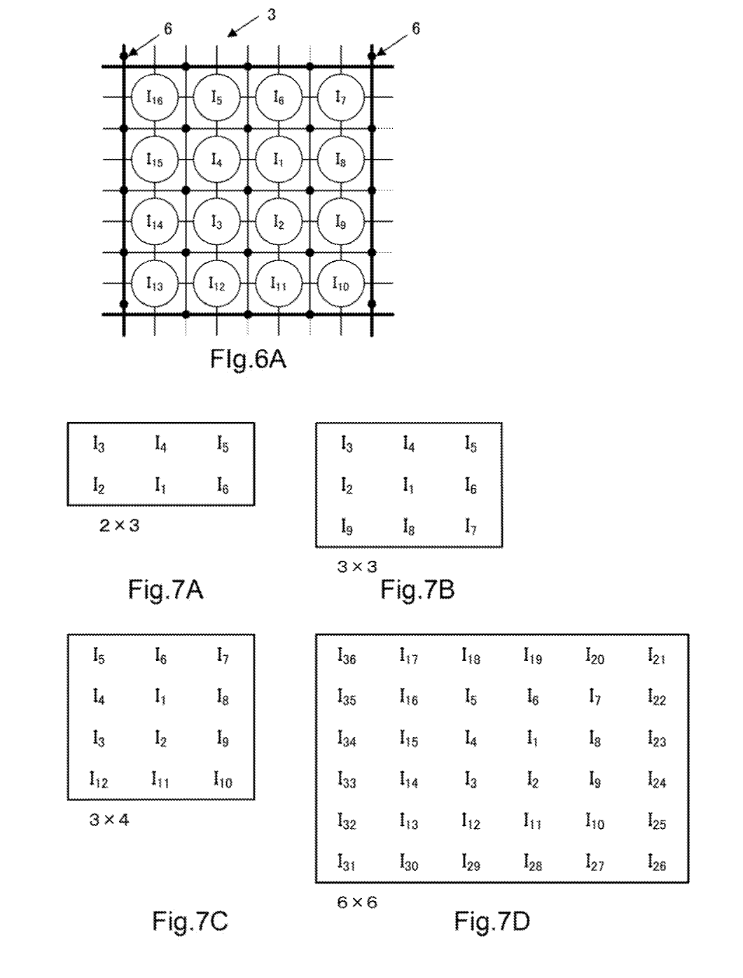

FIG. 6 shows an example of a format used for extracting an information dot 7 from a dot pattern 3. FIG. 6 is an example of format in which grids of I₁ to I₁₆ are arranged in right-hand spiral from the center of the block. It should be noted that I₁ to I₁₆ in FIG. 6 shows the arrangement of each grid as well as, when one information dot 7 is included per grid, the position of an information dot 7 within each grid.

FIG. 7 shows other examples of arrays of grids that include information dots 7. FIG. 7A is an example of arranging 6 (i.e., 2×3) grids in a block; FIG. 7B is an example of arranging 9 (i.e., 3×3) grids in a block; FIG. 7C is an example of arranging 12 (i.e., 3×4) grids in a block; FIG. 7D is an example of arranging 36 grids in a block. As shown in FIGS. 7A to 7D, the number of grids included in a block of a dot pattern 3 is not limited to 16, and may vary in many ways.

That is, the information amount that can be stored in a dot pattern 3 can be flexibly adjusted, by adjusting the number of grids included in a block and the number of information dots 7 included in a grid depending on the volume of required information and the resolution of the scanner 4.

<GRID5>

FIGS. 8A to 8C show an example of another dot pattern 3b (GRID5). FIG. 8A shows the position relationship among reference point dots 8a to 8e, virtual reference points 9a to 9d, and an information dot 7 in the dot pattern 3b.

The dot pattern 3b defines the direction of the dot pattern 3b using the shape of the block. First, in GRID5, reference point dots 8a to 8e are arranged. The shape indicating the orientation of the block is defined by the lines connecting the reference point dots 8a to 8e (here, a pentagon facing upward). Next, based on the arrangement of the reference point dots 8a to 8e, virtual reference points 9a to 9d are defined. Next, vectors which have directions and lengths with the virtual reference points 9a to 9d as the respective starting points. Finally, an information dot 7 is disposed at the end of the vectors.

In this way, in GRID5, the orientation of a block can be defined by the manner in which the reference point dots 8a to 8e are arranged. Further, the whole size of the block is also defined when the orientation of the block is defined.

FIG. 8B shows an example of defining information based on the fact whether an information dot 7 exits over the virtual reference points 9a to 9d of the block.

FIG. 8C shows an example in which each two of the blocks of GRID5 are connected in horizontal and vertical directions respectively. However, the directions in which the blocks are connected and arranged are not limited to horizontal and vertical directions and the blocks may be arranged and connected in any directions.

It should be noted that, although, in FIGS. 8A to 8C, the reference point dots 8a to 8e and information dots 7 are shown as being the same shapes, the reference point dots 8a to 8e and information dots 7 may take different shapes, for example, the reference point dots 8a to 8e may be larger than the information dots 7. Moreover, the reference point dots 8a to 8e and information dots 7 may take any shapes as long as they can be distinguished, and may be a circle, a triangle, a square or other polygons.

<About Dot Code Format>

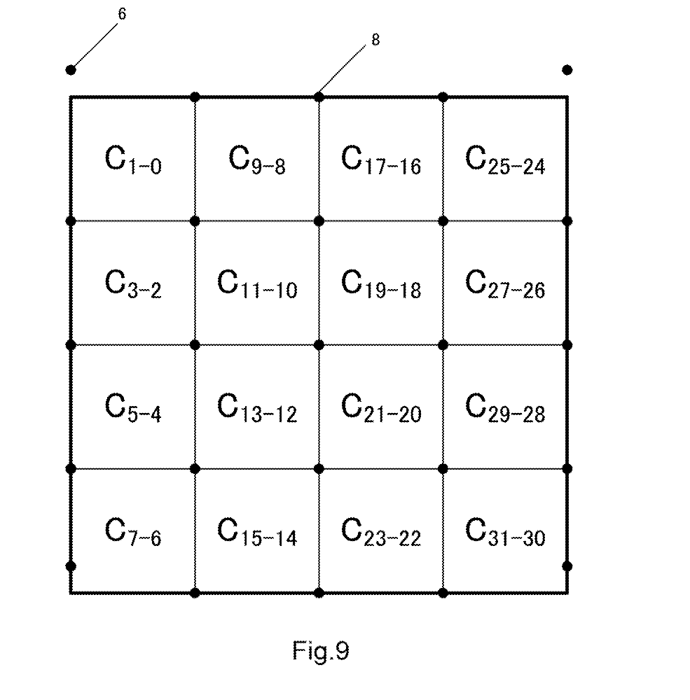

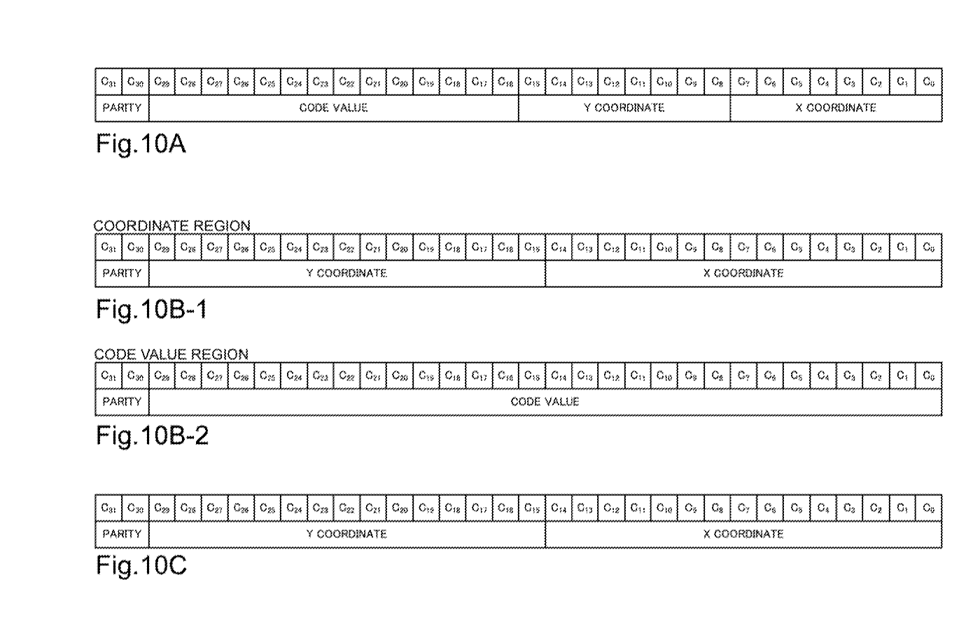

A dot code and examples of the formats are described with reference to FIGS. 9 to 10C. A dot code is information stored in a dot pattern 3.

FIG. 9 shows an example of an information-bit format within a block of a dot pattern 3. In this example, 2-bit information is stored per grid. For example, the grid at the upper left, bits C₀ and C₁ are defined with bit C₁ as the highest-order bit. These 2 bits are collectively described as C₁₋₀. It should be noted that 3 bits may be stored in one information dot 7 per grid or a plurality of information dots 7 per grid.

FIGS. 10A to 10C show examples of dot code formats. In these examples, the dot codes are 32 bit long and expressed with bits C₀ to C₃₁.

FIG. 10A is an example of a format in which the dot code includes XY coordinate values, a code value, and a parity. FIG. 10B is an example in which the format is changed in accordance with the place where the dot pattern 3 is provided. FIG. 10C is an example of a format in which the dot code includes XY coordinate values and a parity.

In the format example shown in FIG. 10A, an X coordinate value of the position where the dot pattern 3 is provided is expressed using 8 bits from bit C₀ to C₇, and similarly, a Y coordinate value is expressed using bit C₈ to C₁₅. Next, the code value is expressed using 14 bits from bit C₁₆ to C₂₉. This code value can be used for expressing arbitrary information in accordance with a use purpose of the dot pattern 3. Finally, as a parity of the dot code, 2 bits of bit C₃₀ and C₃₁ are used. It should be noted that the parity calculation method is not described since a generally known method may be used.

In the format example shown in FIG. 10B, the format changes depending on the place where the dot pattern 3 is provided. In this example, the place where the dot pattern 3 is provided is divided into an XY coordinate region and a code value region. The format for XY coordinate region is used in the XY coordinate region and the format for code value region is used in the code value region.

In the format for XY coordinate region, an X coordinate is expressed using 15 bits from bit C₀ to C₁₄, and similarly, a Y coordinate is expressed using 15 bits from C₁₅ to C₂₉. Also, in the format for code value region, a code value is expressed using 30 bits from C₀ to C₂₉.

It should be noted that the expression rule of bit sequences should be determined so that the bit sequences expressing the XY coordinate value and code value would not overlap in order to distinguish whether the read information expresses an XY coordinate value or a code value.

In this way, compared with the format shown in FIG. 10A, the format example shown in FIG. 10B can allocate larger number of bits to XY coordinate values and code values, which allows wider range of XY coordinate values and greater number of code values to be expressed.

The format example shown in FIG. 10C uses the same format as the one for XY coordinate region.

<Description of Index Using GRID5>

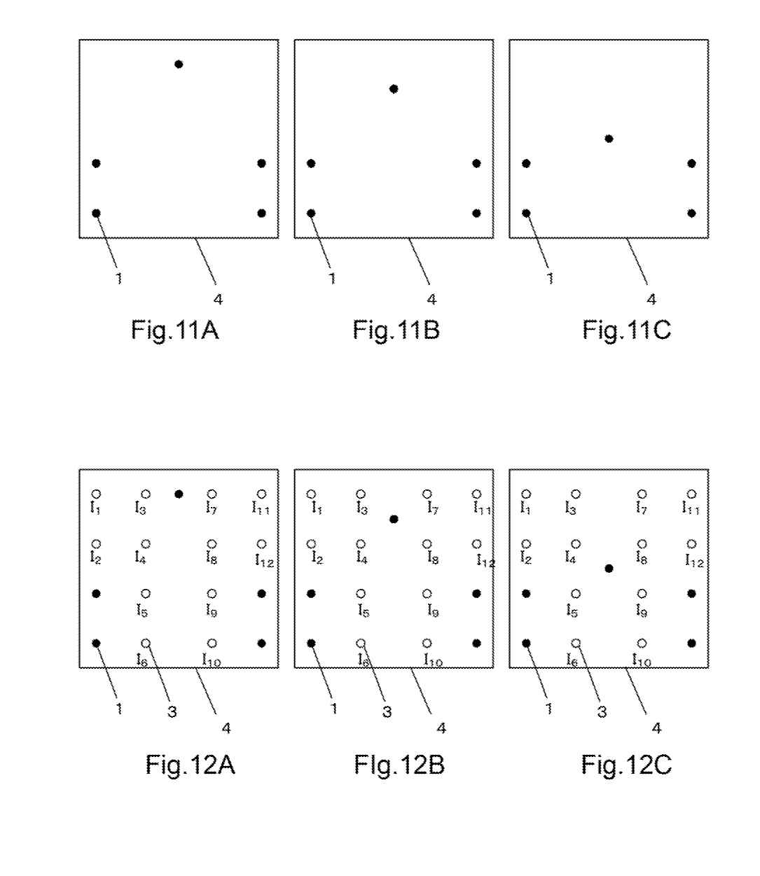

A method that uses an arrangement of reference dots of GRID5 as an index is described using an example with reference to FIGS. 11A to 13C. In this example, a dot code format is associated with an index.

FIGS. 11A to 11C show arrangements of three reference dots. For example, the arrangement of the reference dot shown in FIG. 11A is assumed as A1; the arrangement of the reference dot shown in FIG. 11B is assumed as A2; and the arrangement of the reference dot shown in FIG. 11C is assumed as A3.

FIGS. 12A to 12C show arrangements of virtual reference points in A1, A2 and A3. FIG. 12A shows the arrangement of the virtual reference point in A1; FIG. 12B shows the arrangement of the virtual reference point in A2; and FIG. 12C shows the arrangement of the virtual reference point in A3. An information dot of 2-bit information is assumed to be arranged at each virtual reference point, and 2-bit information is stored respectively in the positions of the virtual reference points I₁ to I₁₂ shown in FIGS. 12A to 12C. Thus, one block stores 24-bit information. As for each of such 24-bit dot-code formats, A1 is associated with an XY coordinate value, A2 is associated with a code value, and A3 is associated with both an XY coordinate value and a code value.

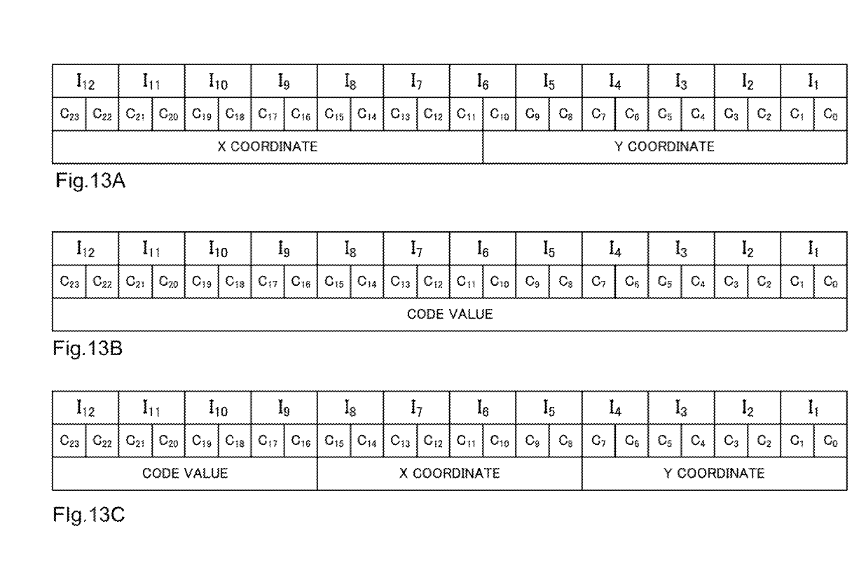

FIGS. 13A to 13C show 24-bit dot-code formats. FIG. 13A is a format of the case of A1; FIG. 13B is a format of the case of A2; and FIG. 13C is a format of the case of A3.

As described above, associating the dot-code format information with the arrangement of a reference dot can also determine the way in which the dot code of the block is used.

It will be appreciated that the bit number of information dots is not limited to 2 bits and the content of the format is not limited to the same one as in the example.

Next, the code pattern of the invention will be described.

### First Embodiment

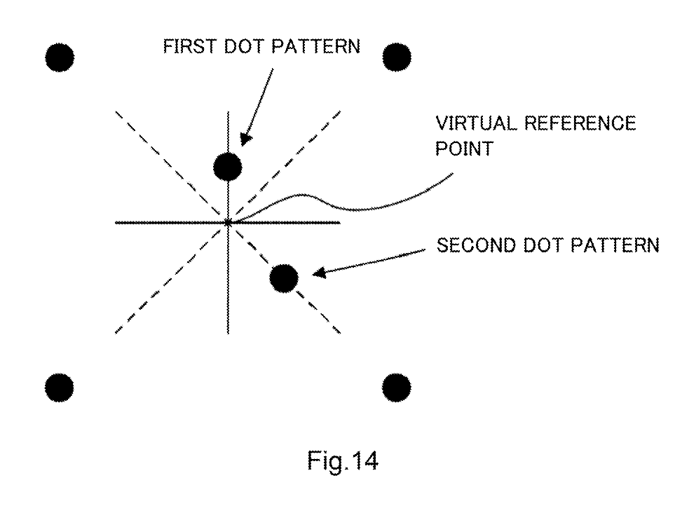

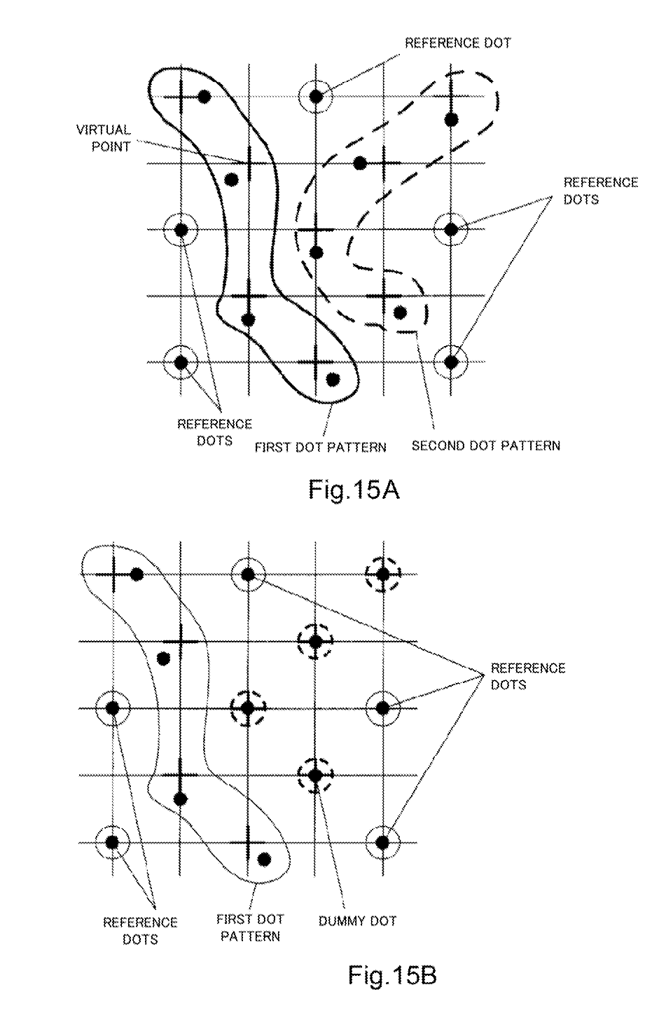

FIGS. 14 to 15B are diagrams illustrating the first embodiment of the invention.

The embodiment relates to a dot pattern in which a first dot pattern is provided on one side or both sides of a medium surface of a card or the like, and a second dot pattern that is made into a pattern based on an arrangement rule different from the first dot pattern is provided on a region overlapping the region where the first dot pattern is provided.

FIG. 14 is a diagram showing dot patterns that have the same virtual reference points, yet have different directions for providing information (the arrangement rules are different).

FIG. 14 shows an example of the embodiment in the case in which dot patterns are the dot patterns of GRID1 as described above. The first dot pattern and the second dot pattern have the same virtual central points and reference grid point dots. However, the directions for providing information dots are different. That is, information is defined in a + direction in the first dot pattern, and a x direction in the second dot pattern. When an engine for recognizing information dots arranged in a + direction is activated, the engine converts only the information dot arranged in the + direction, that is, the first dot pattern, into a code value or a coordinate value from the read dot pattern, and performs a corresponding process. On the other hand, when an engine for recognizing information dots arranged in a x direction is activated, the engine converts only the information dot arranged in the x direction, that is, the second dot pattern, into a code value or a coordinate value from the read dot pattern, and performs a corresponding process.

FIGS. 15A and 15B show an example of the embodiment in a dot pattern of GRID5 described above. In FIGS. 15A and 15B, reference dots are the same, yet virtual reference points are different.

In FIG. 15A, a virtual reference point is arranged based on a reference dot, and an information dot is arranged with the virtual reference point as the starting point. In this embodiment, the first dot pattern and the second dot pattern exist in the same block. The first dot pattern is a dot pattern with the virtual reference point on the left side of the block as the starting point, and the second dot pattern is a dot pattern with the virtual reference point on the right side of the block as the starting point.

An engine for recognizing the first dot pattern and an engine for recognizing the second dot pattern are registered in the computer. If the engine for recognizing the first dot pattern is activated, after reading of the dot pattern by the optical reading unit, the CPU (Central Processing Unit) in the personal computer converts only the first dot pattern from the read dot pattern into a code value and/or a coordinate value, and performs a corresponding process. On the other hand, if the engine for recognizing the second dot pattern is activated, after reading of the dot pattern by the optical reading unit, the CPU (Central Processing Unit) in the personal computer converts only the second dot pattern from the read dot pattern into a code value and/or a coordinate value, and performs a corresponding process.

FIG. 15B is a diagram illustrating a dot arrangement when only one dot pattern is required to be used from the first and second dot patterns.

To use only one kind of dot pattern, as shown in FIG. 15B, an information dot is arranged only in the first dot pattern. In that case, if no dot is arranged in the second dot pattern at all, moire is caused to be developed. Then a dummy dot is arranged on a virtual reference point. A dummy dot is a dot that has given no information. In this way, development of moire can be prevented.

### Second Embodiment

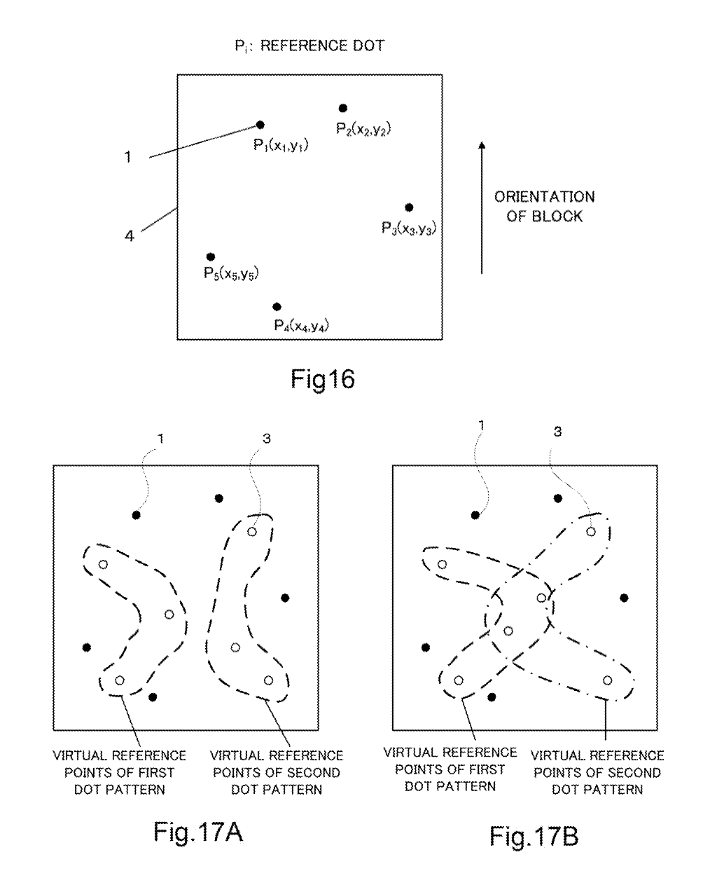

FIGS. 16 to 19C are diagrams illustrating the second embodiment of the invention.

The embodiment uses GRID5 for a first and a second dot patterns. Also, the embodiment relates to a case where all the reference dots of the first dot pattern and the second dot pattern overlap. Such dot patterns are arranged on a medium surface and read out as image information by the optical reading unit connected to an information-processing device, and processed by the information-processing device to be used for a variety of use purposes including an operation and an information input.

The way in which the arrangements of the first and second virtual reference points are registered to the information-processing device is described with reference to FIGS. 16 to 17B.

FIG. 16 is a diagram relating to an arrangement of reference dots within a block.

As shown in FIG. 16, reference dots P₁ to P₅ are arranged at arbitrary positions in a block, which is registered in an information-processing device in advance. The registration is performed by expressing the positions where the reference dots are arranged using coordinate values in a predetermined block region, and storing the coordinate values in the storage unit. Specifically, as shown in FIG. 16, if the reference dots are arranged at P₁ to P₅, the dots are registered as coordinate values from (x₁, y₁) to (x₅, y₅), respectively. Further, in this arrangement, upward is registered as the orientation of the block.

As shown in FIGS. 17A and 17B, virtual reference points of the first and the second dot patterns that are associated with the positions of the reference dots P₁ to P₅ are registered in the information-processing device. As for the registration method, the reference points are registered as coordinate information in the similar way to the reference dots.

FIG. 17A is a case where the virtual reference points of the first and second dot patterns do not overlap. FIG. 17B is a case where part of the virtual reference points of the first dot pattern (two virtual reference points in FIG. 17B) and part of the virtual reference points of the second dot pattern (two virtual reference points in FIG. 17B) overlap. It will be appreciated that all the virtual reference points of the first and second dot patterns may overlap.

When a virtual reference point is determined, the arranging rule of information dots arranged near the virtual reference point is also determined, provided, however, if the virtual reference points of the first and second dot patterns overlap, the arranging rules of the information dots used at the overlapping virtual reference points should necessarily be different. If not so, the arranged information dots cannot be distinguished whether the information dots belong to the first dot pattern or the second dot pattern.

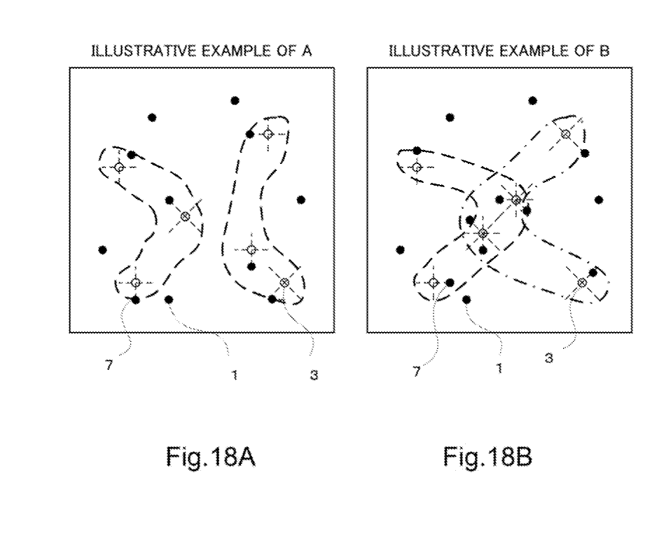

FIGS. 18A and 18B show illustrative examples of arranged information dots.

FIG. 18A is an illustrative example when virtual reference points of the first and second dot patterns do not overlap. FIG. 18B is an illustrative example when part of the virtual reference points of the first dot pattern (two virtual reference points in FIG. 18B) and part of the virtual reference points of the second dot pattern (two virtual reference points in FIG. 18B) overlap.

As described above, when part of the virtual reference points of the first dot pattern (two virtual reference points in FIG. 18B) and part of the virtual reference points of the second dot pattern (two virtual reference points in FIG. 18B) overlap, it should be noted that the arranging rules of the virtual reference points are different as shown in FIG. 18B. In FIG. 18B, the arranging rules at the overlapping virtual reference points are differentiated by using a + direction for the arranging rule of all the information dots of the first dot pattern and using a x direction for the arranging rule of all the information dots of the second dot pattern

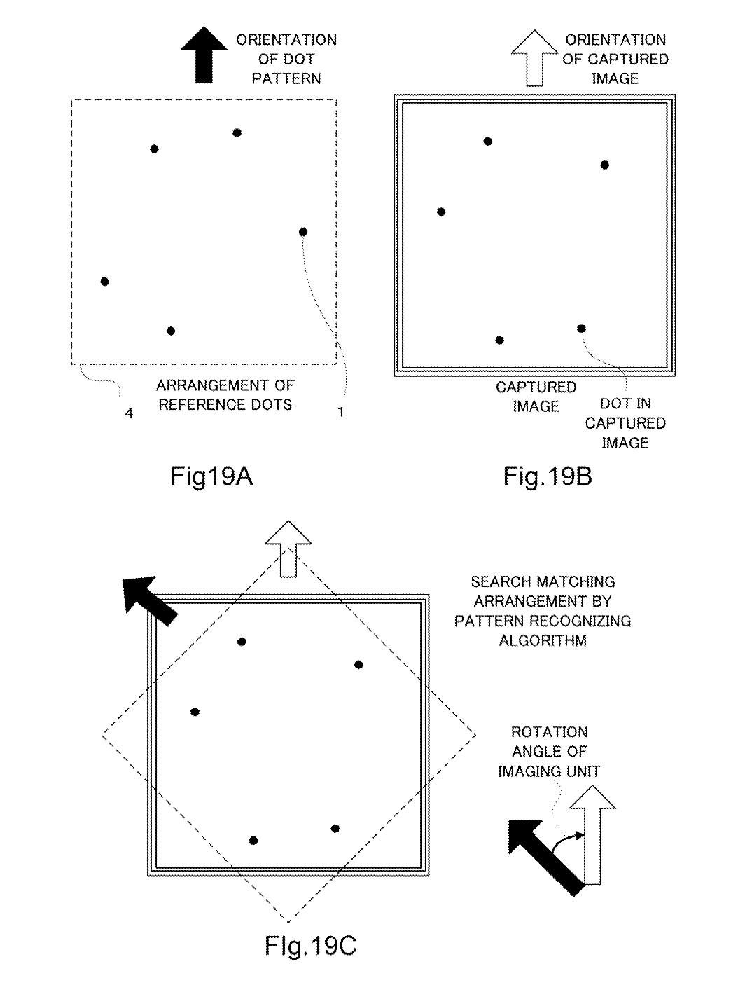

A method for causing recognition of dots that match the positions of reference dots from a captured image is described with reference to FIGS. 19A to 19C.

FIG. 19A shows one of the positions of reference dots registered in the information-processing device. FIG. 19B shows the captured image read out by the reading unit (information bits are not shown). As shown in FIG. 19C, generally known pattern-recognizing algorithm finds out a group of dots that exactly match the positions of reference dots from the captured image. Here, as shown in FIG. 19C, the rotation angle of the imaging unit can be determined based on the difference between the orientation of the block and the orientation of the captured image.

### Third Embodiment

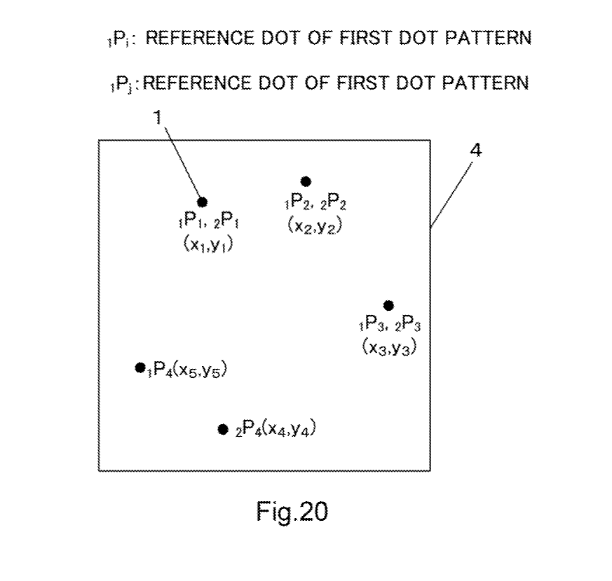

FIGS. 20 to 22 are diagrams illustrating a third embodiment of the invention.

The embodiment relates to a case where part of reference dots of a first dot pattern and part of reference dots of a second dot pattern overlap.

Arrangements of the reference dots of the first and second dot patterns are described with reference to FIG. 20. A reference point of the first dot pattern is expressed as ₁Pⱼ, a reference point of the second dot pattern is expressed as ₂Pⱼ. In this case, ₁P₁ to ₁P₃ match ₂P₁ to ₂P₃, yet ₁P₄ do not match ₂P₄.

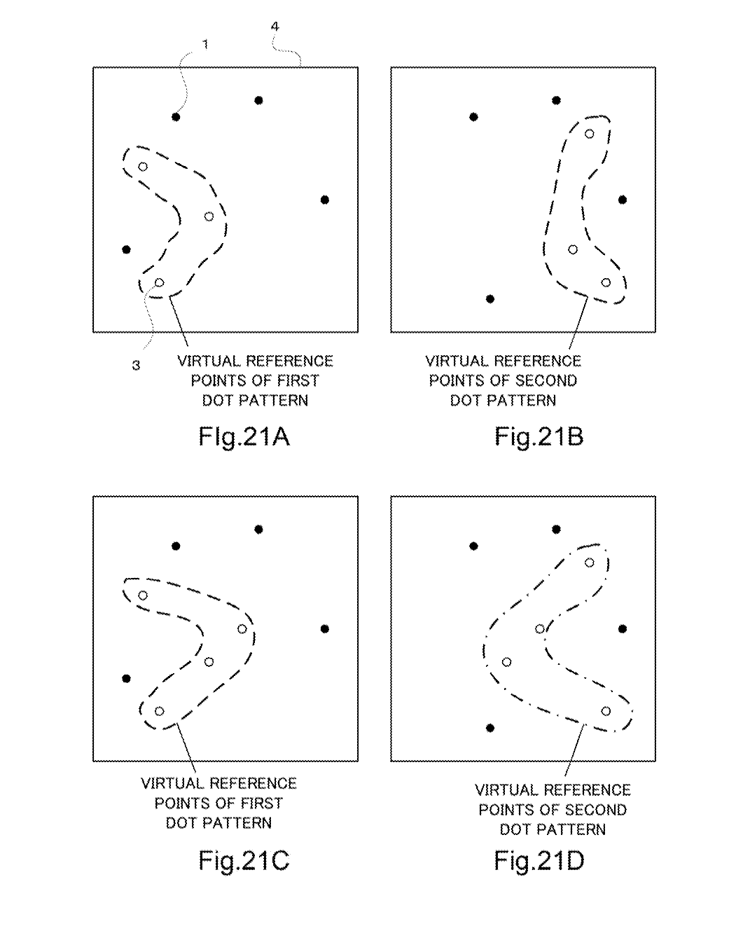

FIGS. 21A to 21D are diagrams showing arrangement positions of virtual reference points of the first and second dot patterns.

FIGS. 21A and 21B are positions of virtual reference points of the first and second dot patterns when virtual reference points do not overlap.

FIGS. 21C and 21D are positions of virtual reference points of the first and second dot patterns when part of virtual reference points overlap.

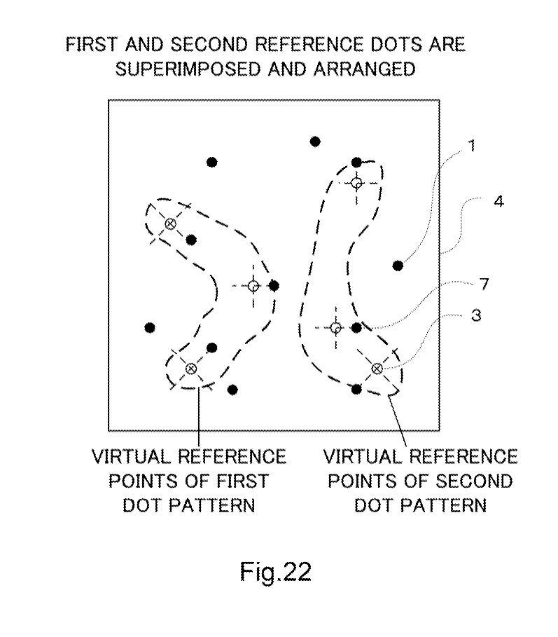

FIG. 22 shows an example of a case where information dots are arranged and virtual reference points do not overlap.

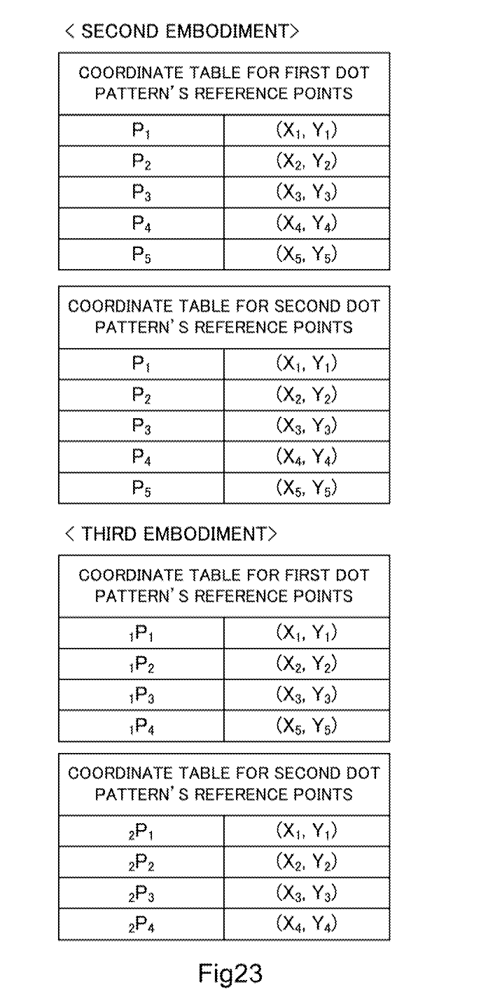

FIG. 22 is similar to FIGS. 17A and 17B of the second embodiment, but the tables relevant to the arrangement of reference dots that information-processing devices have are different. When detecting the first dot pattern, only the arrangement of the reference dots of the first dot pattern is searched from the captured image. FIG. 23 shows tables of the second and third embodiments.

### Fourth Embodiment

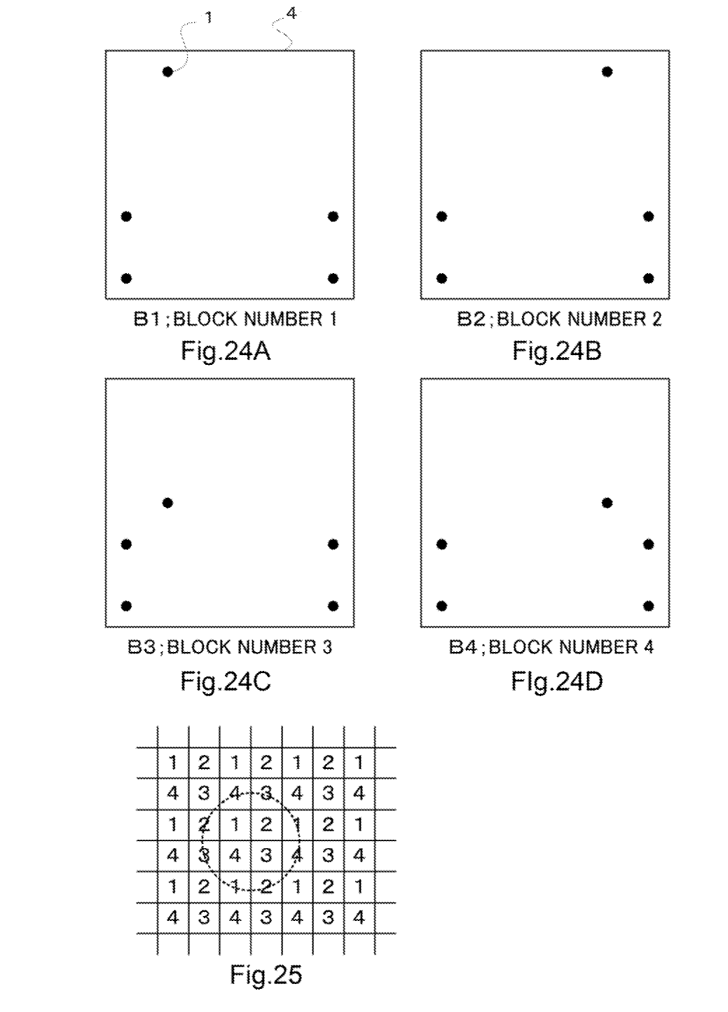

FIGS. 24A to 25 are diagrams illustrating a fourth embodiment of the invention.

The embodiment is a case where a block number is associated with an arrangement of a reference dot.

A method for associating an arrangement of a reference dot and a block number is described with reference to FIGS. 24A to 24D.

The arrangement of the reference dot in FIG. 24A is assumed as B1; the arrangement of the reference dot in FIG. 24B is assumed as B2; the arrangement of the reference dot in FIG. 24C is assumed as B3; and the arrangement of the reference dot in FIG. 24D is assumed as B4. Although not shown in the drawings, a table for associating block number 1 to B1, block number 2 to B2, block number 3 to B3, and block number 4 to B4 is provided. The total number of the blocks is set using the table. Alternatively, for example, the total number may be set by a program, such that the number of reference dots disposed at the same positions (in this example, four dots) represents the total number of the blocks.

As shown in FIG. 25, blocks are arranged in series. The numbers indicated within the blocks are the block numbers. It should be noted that information dots are not shown in FIG. 25.

By arranging block numbers as shown in FIG. 25, all one to four blocks can be imaged by reading any one of four blocks. Therefore, it is not required to shift the imaging area.

When an information-processing device receives an image of a dot pattern read out by the reading unit, the information-processing device calculates a block number and code information of each block, and then, connects the code information in the order of block numbers 1, 2, 3, and 4.

In this way, large amount of code information that exceeds the size of one block can be encoded in a dot pattern.

### Fifth Embodiment

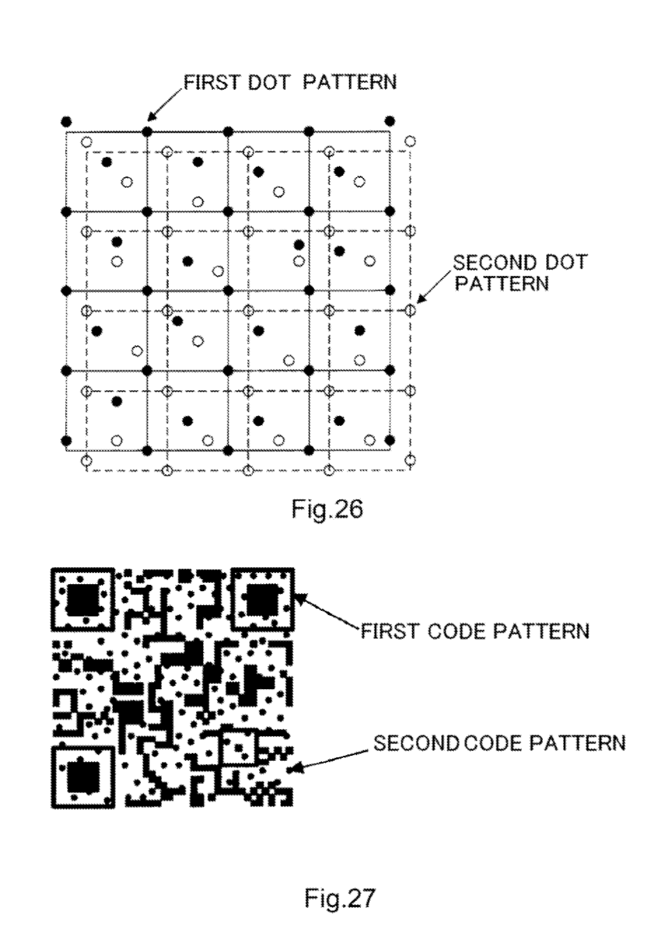

FIGS. 26 to 29 are diagrams illustrating a fifth embodiment of the invention.

The embodiment relates to code patterns where the first code pattern and the second code pattern are provided with inks having characteristics of reacting differently to irradiation light.

FIG. 26 is a diagram illustrating a case where the first code pattern and the second code pattern are both dot patterns.

In FIG. 26, dots constituting the first dot pattern are indicated in black, and dots constituting the second dot pattern are indicated in white. The first dot pattern and the second dot pattern are formed in the same region.

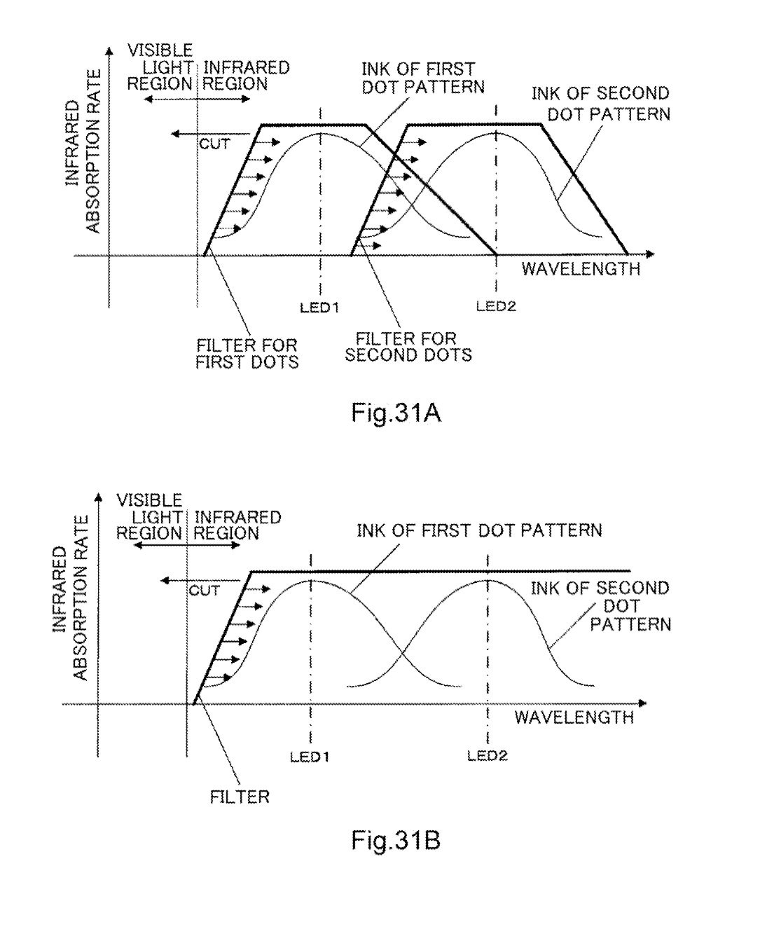

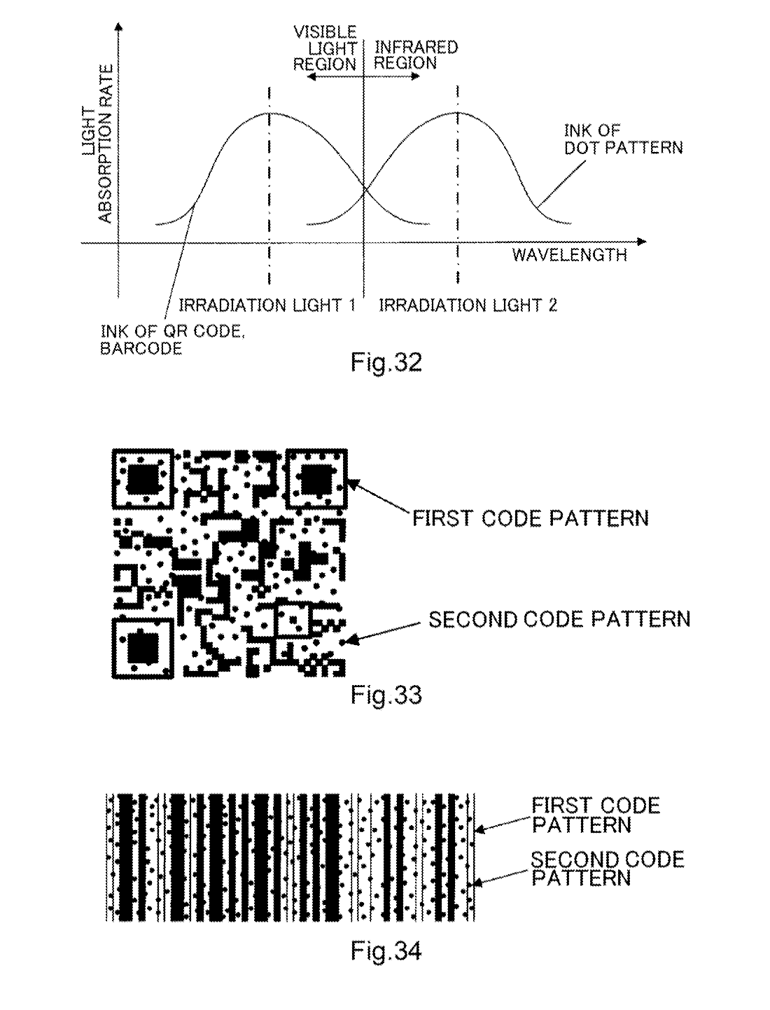

Reactions to the irradiation light in this case are specifically illustrated with reference to FIGS. 30 to 31B.

FIG. 30 is an example of a case where there is one source of irradiation light. The dot pattern of the first dot pattern (the first code pattern) is formed with an ink having peak wavelength of λ1, and the dot pattern of the second dot pattern (the second code pattern) is formed with an ink having peak wavelength of λ2. On the other hand, an LED as an infrared irradiation unit has a wavelength characteristic in the region shown in FIG. 30.

When the LED is irradiated in such a case, the ink of the first dot pattern has higher infrared absorption rates than the ink of the second dot pattern. Therefore, the first dot pattern of higher infrared absorption rates is recognized.

FIGS. 31A and 31B are examples of cases where there are two sources of irradiation light. FIG. 31A is a diagram illustrating a case using two kinds of filters, and FIG. 31B is a diagram illustrating a case using one kind of filter. These filters transmit only specific infrared wavelengths and are disposed on the imaging unit for reading dot patterns.

FIG. 31A uses two kinds of filters: a filter for the first dots and a filter for the second dots. Also, there are two kinds of irradiation light; LED1 has a wavelength characteristic around the peak wavelength of the first dot pattern, and LED2 has a wavelength characteristic around the peak wavelength of the second dot pattern.

If the filter for the first dots is disposed, infrared rays other than the region of the filter for the first dots shown in FIG. 31A are cut out. Thus, even if both LED1 and LED2 are lit, since only the irradiation light of LED1 is transmitted, the ink of the first dot pattern absorbs the irradiation light of LED1 and only the first dot pattern is recognized.

On the other hand, if the filter for the second dot pattern is disposed, irradiation rays other than the region of the filter for the second dots shown in FIG. 31A are cut out. Thus, even if both LED1 and LED2 are lit, since only the irradiation light of LED2 is transmitted, the ink of the second dot pattern absorbs the irradiation light of LED2 and only the second dot pattern is recognized.

In this way, disposing a filter for dots on the imaging unit allows recognition of different code patterns that are superimposed and printed together.

FIG. 31B uses a filter that transmits both infrared wavelengths in the wavelength region of the first dots and the wavelength region of the second dots. As in the case of FIG. 31A, LED1 has a wavelength characteristic around the peak wavelength of the ink of the first dot pattern, and LED2 has a wavelength characteristic around the peak wavelength of the ink of the second dot pattern. When only LED1 is lit, only the first dot pattern is recognized, while when only LED2 is lit, only the second dot pattern is recognized.

It should be noted that, although a case where two kinds of LED sources are used is described above, the embodiment is not limited to this and one unit of irradiation device capable of selecting irradiation light's wavelengths may be used.

Irradiation light 1 has a wavelength characteristic around the peak wavelength of the ink of the first code pattern, and irradiation light 2 has a wavelength characteristic around the peak wavelength of the ink of the second code pattern. When only the irradiation light 1 is lit, only the first code pattern is recognized, while when only the irradiation light 2 is lit, only the second code pattern is recognized.

In this way, by selectively changing irradiation light to irradiate, different code patterns that are superimposed and printed together can be recognized.

FIG. 27 is a diagram illustrating a case where the first code pattern is a QR code and the second code pattern is a dot pattern. It should be noted that, in FIG. 27, the first dot patterns are consecutively and repeatedly arranged in lateral and longitudinal directions in the region occupied by the QR code.

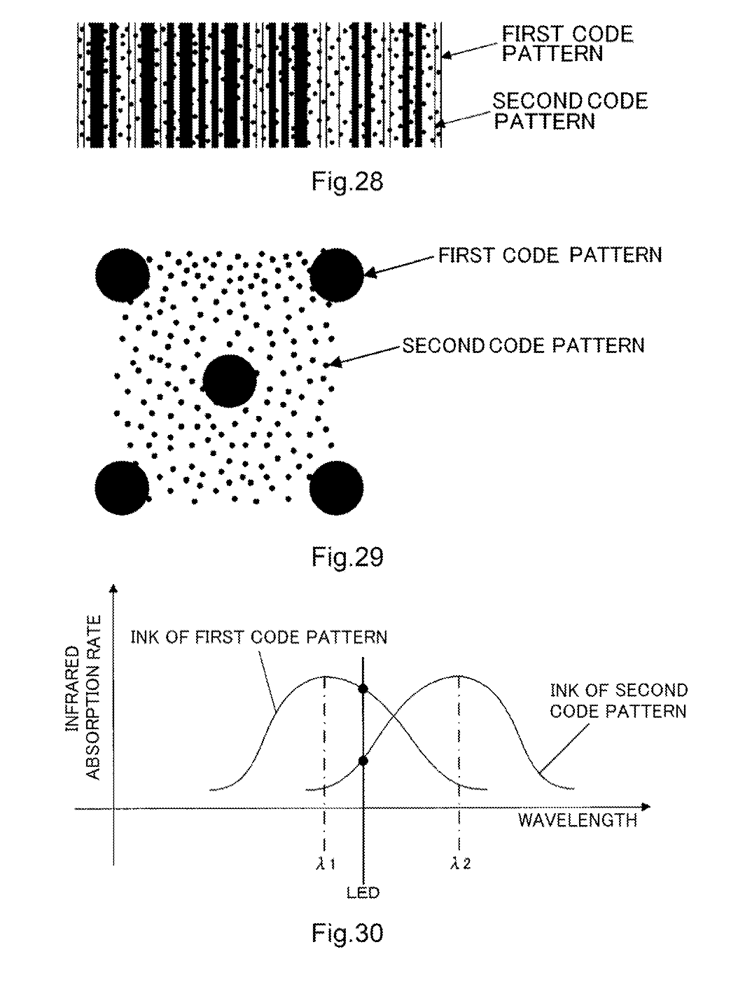

Also, FIG. 28 is a diagram illustrating a case where the first code pattern is a barcode and the second code pattern is a dot pattern. It should be noted that, in FIG. 28, the first dot patterns are consecutively and repeatedly arranged in lateral and longitudinal directions in the region occupied by the barcode.

The wavelength characteristics in FIG. 27 and FIG. 28 are as shown in FIG. 33. That is, the QR code of FIG. 27 and the barcode of FIG. 28 are printed with an ink that absorbs visible light. On the other hand, the dot patterns are printed using an ink that absorbs infrared rays.

The irradiation light 1 has a wavelength characteristic around the peak wavelength of the ink of the first code pattern, that is, visible light region, and the irradiation light 2 has a wavelength characteristic around the peak wavelength of the ink of the second code pattern, that is, infrared region. When only the irradiation light 1 is lit, only the first code pattern is recognized, while when only the irradiation light 2 is lit, only the second code pattern is recognized.

In this way, by selectively changing irradiation light to irradiate, different code patterns that are superimposed and printed together can be recognized.

FIG. 29 is a diagram illustrating a case where the first code pattern and the second code pattern are both dot patterns. In FIG. 29, the sizes of dots are different between the first code pattern and the second code pattern.

The wavelength characteristics in this case are as shown in FIG. 31. The method for recognizing the first dots and the second dots is the same as the one described before, so the method is not described here.

### Third Embodiment

FIGS. 34 to 36 are diagrams illustrating a third embodiment of the invention.

The embodiment selects a code pattern to be employed based on the resolution of an imaging element when the first code pattern or the second code pattern is a dot pattern formed with fine dots.

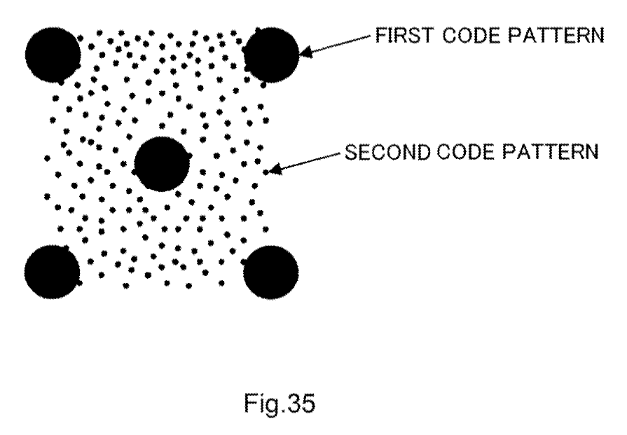

In FIG. 34, the first code pattern is a QR code and the second code pattern is a dot pattern. In FIG. 35, the first code pattern is a barcode and the second code pattern is a dot pattern. In FIG. 36, the first code pattern is a large dot pattern and the second code pattern is a small dot pattern.

With such code patterns, it is possible to select which code pattern is to be employed by irradiating irradiation light with different wavelength characteristics, as described above. However, other than that, it is also possible to select code patterns to be employed based on the difference between the resolutions of the imaging elements.

In FIG. 34, for example, the QR code as the first code pattern is read out by an imaging device provided on a mobile phone. Since the imaging device of the mobile phone recognizes the dots as a noise, only the first code pattern is employed as a code pattern. On the other hand, the dot pattern as the second code pattern is read out by the imaging device whose irradiation light is infrared rays. In such a case, the QR code is not recognized and only the dot pattern is recognized. If should be noted that, in FIG. 34, the first dot patterns are consecutively and repeatedly arranged in longitudinal and lateral directions in a region occupied by the QR code.

In the case of FIG. 35, the barcode is read out by a dedicated barcode reader. Since the barcode reader recognizes the dots as a noise, only the first code pattern is employed as a code pattern. On the other hand, a dot pattern as the second code pattern is read out by an imaging device that uses infrared rays as irradiation light. In such a case, the barcode is not recognized and only the dot pattern is recognized. It should be noted that, in FIG. 35, the first dot patterns are consecutively and repeatedly arranged in longitudinal and lateral directions in a region occupied by the barcode.

In FIG. 36, large dots are read by an imaging device positioned at a place apart from the medium on which the dot pattern is printed. Such an imaging device recognizes only the first code pattern of large dots and cannot recognize the second code pattern of small dots. On the other hand, the small dots as the second code pattern are recognized only by the imaging device (a scanner) that reads a dot pattern by directly touching the medium. This scanner does not recognize the first code pattern.

Further, as described above, other than the method for recognizing the codes using two kinds of imaging devices as described above, there is a method for recognizing the codes using a software program. In such a case, the imaging device is an imaging device with high resolution that can read both the first code pattern and the second code pattern. When the program for analyzing the first code pattern is activated, the imaging device or the central processing unit of a computer analyzes the first code pattern, converts into a value that the code pattern signifies, and performs the corresponding process. When the program for analyzing the second code pattern is activated, the imaging device or the central processing unit of a computer analyzes the second code pattern, converts into a value that the code pattern signifies, and performs the corresponding process.

It should be noted that a code pattern used in the invention (a dot pattern, a barcode, and a two-dimensional code other than dot patterns) is not limited to code patterns described in the above embodiments, and may be the one having another algorithm or embodiment.

The invention can be used for card media, such as a card for card games, an employee card, and a cash card, printed materials, such as a picture book or a catalog, and any other media.
1 REFERENCE DOT
3 VIRTUAL REFERENCE POINT
4 BLOCK
5 DOT PATTERN
6 KEY DOT OF GRID1 (REFERENCE DOT)
7 INFORMATION DOT
8 REFERENCE GRID POINT DOT OF GRID1 (REFERENCE DOT)
8a-8e REFERENCE POINT DOT OF GRID5 (REFERENCE DOT)
9 VIRTUAL GRID POINT OF GRID1 (VIRTUAL REFERENCE POINT)
9a-9d VIRTUAL REFERENCE POINT OF GRID5 (VIRTUAL REFERENCE POINT)

1. A dot pattern that is made into a pattern with a coordinate value and/or a code value based on a predetermined algorithm, provided on at least one surface of a medium, and optically recognizable with an imaging unit, and in which a first and a second dot patterns are superimposed and arranged, wherein
the first and the second dot patterns are dot patterns that provide a plurality of reference dots in regions of blocks on which predetermined dots are arranged, arrange a plurality of virtual reference points defined by the reference dots, arrange information dots that define information by distances and directions from the virtual reference points, and define at least orientations and sizes of the blocks based on arrangements of the reference dots as indexes of the blocks,
the block is arranged so that part of or entire the reference dots and/or the virtual reference dots of the first and second dot patterns are superimposed together, and number of the block is one, or a plurality of the blocks are repeatedly arranged in lateral and longitudinal directions.

2. The dot pattern according to claim 1, wherein information dots are arranged in different forms in the first and the second dot patterns respectively.

3. The dot pattern according to claim 1, wherein the second dot pattern that is made into a pattern in a different size from the first dot pattern is provided on a region overlapping a region on which the first dot pattern is provided,
the first dot pattern and the second dot pattern are read by either one of two systems of imaging units having imaging elements with different resolutions, and either one of the dot patterns is recognizable with the resolution of the imaging unit.

4. The dot pattern according to claim 3, wherein the first dot pattern and the second dot pattern are read by either one of two systems of imaging units that image a medium near the medium or far from the medium, and either one of the dot patterns is recognizable by the imaging unit.

5. The dot pattern according to claim 1, wherein, in addition to the second dot pattern, a one-dimensional code pattern or a two-dimensional code pattern is arranged, and part of or entire the code pattern is superimposed by the first dot pattern.

6. The dot pattern according to claims 1, wherein the first and the second dot patterns are printed with inks with characteristics that react differently to irradiation light.
